(19) United States
(12) Patent Application Publication
(10) Pub. No.: US 2024/0292836 A1
(43) Pub. Date: Sep. 5, 2024

(54) AGENTS FOR REPELLING, KNOCKING DOWN, AND/OR KILLING BLOOD-SUCKING ARTHROPODS AND USES THEREOF

(71) Applicant: The United States of America, as represented by the Secretary of Agriculture, Washington, DC (US)

(72) Inventors: AIJUN ZHANG, LAUREL, MD (US); CODY GALE, ROCKVILLE, MD (US); EDMUND J. NORRIS, GAINSVILLE, FL (US)

(21) Appl. No.: 18/588,691

(22) Filed: Feb. 27, 2024

Related U.S. Application Data
(60) Provisional application No. 63/487,556, filed on Feb. 28, 2023.

(51) Int. Cl. A01N 37/10; A01N 25/02; A01N 37/18; A01N 43/40; A01P 7/00; A01P 7/02; A01P 7/04; A01P 17/00

(52) U.S. Cl. CPC A01N 37/10; A01N 25/02; A01N 37/18; A01N 43/40; A01P 7/00; A01P 7/02; A01P 7/04; A01P 17/00

(57) ABSTRACT

The disclosure provides evaluation of the spatial and topical repellent and knockdown activities of benzoates against blood-sucking arthropods and compared with DEET using both high-throughput in vitro screening tests and arm-in-cage in vivo assays in the laboratory. Tested alone or in blends were methyl benzoate (MB), ethyl benzoate (EB), vinyl benzoate (VB), n-propyl benzoate (nPrB), n-butyl benzoate (nBB), benzyl benzoate (BB), methyl 2-chlorobenzoate (M2CB), methyl 2-nitrobenzoate (M2NB), iso-butyl benzoate (iBB), n-pentyl benzoate (nPeB), n-hexyl benzoate (nHB), methyl 3-methylbenzoate (M3MB), iso-pentyl benzoate (also called iso-amyl benzoate) (iPeB), iso-propyl benzoate (iPrB), methyl 2-methoxybenzoate (M2MOB), ethyl 2-methoxybenzoate (E2MOB), ethyl 4-methoxybenzoate (E4MOB), methyl anthranilate (MA), Methyl 2-(aminosulfonyl)benzoate (M2ASB), n-butyl anthranilate (nBA), methyl 3-nitrobenzoate (M3NB), methyl 4-nitrobenzoate (M4NB), ethyl 3-aminobenzoate (E3AB), allyl anthranilate (AA), methyl 2-methylbenzoate (M2MB), methyl 3-methoxybenzoate (M3MOB), ethyl anthranilate (EA), methyl N-methylanthranilate (MMA), methyl N,N-dimethylanthranilate (MDMA), iso-butyl anthranilate (iBA), methyl N-acetylanthranilate (MAcA), methyl N-formylanthranilate (MFA), ethyl N-formylanthranilate (EFA), n-Propyl N-formylanthranilate (nPrFA), or n-Butyl N-formylanthranilate (nBFA).

### FIELD OF THE INVENTION

This application claims priority benefit from U.S. Provisional Application No. 63/487,556, filed Feb. 28, 2023. The contents of this patent application are hereby expressly incorporated by reference in their entirety.

### FIELD OF THE INVENTION

The invention relates to novel compositions for repelling, knocking down, and/or killing blood-sucking arthropods, methods of using such novel compositions for repelling, knocking down, and/or killing blood-sucking arthropods, and kits comprising such compositions.

### BACKGROUND OF THE INVENTION

Hematophagy is a feeding behavior that has been adopted by many invertebrates, including some insects and arachnids. It is thought to have evolved independently in many different lineages and is often accompanied by specific adaptations of mouthparts for biting and sucking. Blood-feeding arthropods can be regarded as ectoparasites that feed on the blood of their hosts when they are in temporary contact with them (such as mosquitoes, sandflies, tsetse flies, blackflies, tabanids, and blood-feeding bugs), in permanent contact (such as lice, sheep ked, and tungid flies), or in periodic contact (such as fleas and ticks). Many feed on blood only during one particular phase (often the adult female), while others feed on blood throughout their life cycle.

Over 3,000 different mosquito species are known to exist in the word. Aedes, Anopheles, and Culex are the most common vectors mosquitoes that can carry and transmit many serious diseases and viruses, which can result in over 700,000 deaths globally every year.

Chemical control of mosquitos is critical to disease control worldwide, but effective insecticides are limited and the need for novel chemistries is not new. While there are six classes of insecticides recommended for use against mosquitos (organochlorines, organophosphates, carbamates, pyrethroids, pyrroles, and phenyl pyrazoles), pyrethroids are the most widely used, and as a result, pyrethroid resistance in mosquitos is on the rise. Fabrics can be impregnated with pyrethroids so that mosquitos contact the insecticide while trying to bite humans, and pyrethroid-treated bed nets are one of the most effective methods of preventing mosquito-borne disease transmission worldwide. In the United States, military personnel uniforms as well as bed nets are treated with permethrin and combined with a repellent, represent the bulk of the protection offered to military personnel against mosquitos.

Skin-applied insect repellents are the most common form of mosquito bite prevention used by the public. There are seven active ingredients registered with the EPA for use in insect repellents, and they are a combination of synthetic and natural compounds and blends: catnip oil, oil of citronella, oil of lemon eucalyptus, p-menthane-3,8-diol (pmd, a component in oil of lemon eucalyptus but regulated separately), DEET (N,N-diethyl-3-methylbenzamide), IR3535 (3-[N-Butyl-N-acetyl]-aminopropionic acid, ethyl ester, a registered trademark of Merk KGaA, Germany), picaridin (also known as icaridin), and 2-undecanone. The synthetic compound DEET, has been called the “gold standard of insect repellents” as it is highly effective and can be easily found as a component in over a hundred products registered with the EPA. The popular use of DEET presents the same issue of resistance development, which has already been documented in Ae. aegypti.

Thus, development of eco-friendly, safe for humans and pets, substantiable products that reduce the use of synthetic pesticides against blood-sucking arthropod pests are needed.

### SUMMARY OF THE INVENTION

Provided herein are compositions useful for repelling, knocking down, and/or killing blood-sucking arthropods, methods for using such compositions to repel, knockdown, and/or kill arthropods, and kits comprising such compositions.

The invention relates to a blood-sucking arthropod-repelling, knocking down, and/or killing composition comprising a solvent or diluent and a compound of Formula 1 or Formula 2:

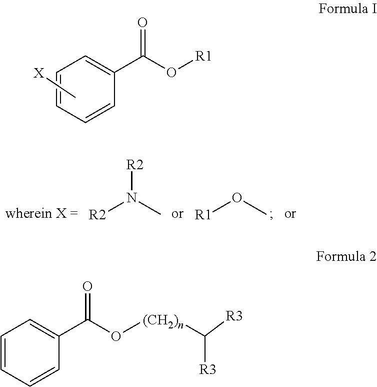

wherein
n is 1, 2, 3, or 4;
R1 are independently an alkyl or alkenyl groups;
R2 are independently hydrogen, oxygen, aldehyde, ketone, acetyl, alkyl, or alkenyl groups; and
R3 are independently hydrogen, halogen, or CH₃ groups.

In an embodiment, the disclosure relates to a method for repelling, knocking down, and/or killing blood-sucking arthropods present in an object or area. The method comprising contacting an object or area with an effective amount of a composition taught herein, and optionally a carrier to repel, knockdown, and/or kill blood-sucking arthropods on the object or area.

In an embodiment, the disclosure relates to a kit comprising a composition taught herein for repelling, knocking down, and/or killing blood-sucking arthropods.

### BRIEF DESCRIPTION OF THE DRAWINGS

FIG. 1 depicts a schematic of the synthetic pathway for the preparation of N-formylanthanilate analogs disclosed herein. n=0, 1, or 2.

FIG. 2A to FIG. 2D depict graphs of the EI MS spectra obtained for N-amidobenzoates consisting of anthranilates carrying an N-formyl group. FIG. 2A shows the results for methyl N-formylanthranilate (MFA). FIG. 2B shows the results for ethyl N-formylanthranilate (EFA).

FIG. 2C shows the results for n-Propyl N-formylanthranilate (nPrFA). FIG. 2D shows the results for n-Buty N-formylanthranilate (nBFA). The Y Axis shows the relative abundance. The X Axis shows the mass to charge ratio (m/z).

FIG. 3 depicts a graph of the percentage of baseline nerve firing of larval Aedes aegypti central nervous system exposed independently to 100 μM of various experimental compounds. DMSO; nBB; nPeB; M2NB; M2MOB; MA; and iBB. The Y Axis shows the percent (%) of baseline activity. The X Axis shows the time after drug challenge in minutes.

FIG. 4 depicts a graphs of the 30-minute RD₅₀ values and 95% confidence intervals from the high-throughput in vitro screening. The Y Axis shows the calculated RD₅₀ (μg/cm²) and 95% confidence interval (95% CI). The X Axis shows compounds shown in Table 1 to have RD₅₀ values less than 100 μg/cm². DEET, the positive control, is the leftmost compound, and the test compounds are ordered from left to right by increasing RD₅₀ values. Marked with circles are compounds that did not behave significantly different from DEET (similar repellents), and compounds marked with triangles presented with significantly lower RD₅₀ values than that of DEET (better repellents).

FIG. 5 depicts a graph of the 60 minute RD₅₀ values and 95% confidence intervals from the high-throughput in vitro screening. The Y Axis shows the calculated RD₅₀ (μg/cm²) and 95% confidence interval (95% CI). The X Axis shows compounds shown in Table 1 to have RD₅₀ values less than 100 μg/cm². DEET, the positive control, is the leftmost compound, and the test compounds are ordered from left to right by increasing RD₅₀ values. Marked with circles are compounds that did not behave significantly different from DEET (similar repellents), compounds marked with triangles presented with significantly lower RD₅₀ values than that of DEET (better repellents), and compounds marked with squares presented with significantly higher RD₅₀ values than DEET (worse repellents).

FIG. 6A to FIG. 6E depict graphs of the knockdown effects of alkyl benzoates at different doses over time. The Y Axis shows the percent knockdown (% KD). The X Axis shows the time after exposure in minutes. FIG. 6A shows data for nBB. Circles (●) represent 2 μg/cm³, triangles (▴) represent 3 μg/cm³, squares (▪) represent 4 μg/cm³, plus signs (+) represent 5 μg/cm³, and squares filled with x ( [symbol] ) represent 6 μg/cm³. FIG. 6B shows data for iBB. Circles (●) represent 1 μg/cm³, triangles (▴) represent 3 μg/cm³, squares (▪) represent 5 μg/cm³, and plus signs (+) represent 7 μg/cm³. FIG. 6C shows data for nPeB. Circles (●) represent 3 μg/cm³, triangles (▴) represent 4 μg/cm³, squares (▪) represent 5 μg/cm³, plus signs (+) represent 6 μg/cm³, squares filled with x ( [symbol] ) represent 7 μg/cm³, and asterisks (*) represent 8 μg/cm³. FIG. 6D shows data for iPeB. Circles (●) represent 3 μg/cm³, triangles (▴) represent 4 μg/cm³, squares (▪) represent 5 μg/cm³, and plus signs (+) represent 6 μg/cm³. FIG. 6E shows data for nHB. Circles (●) represent 2 μg/cm³, triangles (▴) represent 3 μg/cm³, squares (▪) represent 4 μg/cm³, plus signs (+) represent 5 μg/cm³, and squares filled with x ( [symbol] ) represent 6 μg/cm³.

### DETAILED DESCRIPTION

Described herein are novel compositions for repelling, knocking down, and/or killing blood-sucking arthropods, methods of using such novel compositions for repelling, knocking down, and/or killing blood-sucking arthropods, and kits comprising such novel compositions.

Mosquito bites on humans can transmit many serious diseases and viruses, which can result in over 700,000 deaths globally every year. Currently, synthetic pesticides are still the most common approach to control mosquito populations. However, the overuse of pesticides has caused mosquitoes to develop resistance, which results in huge negative impacts on public health, wildlife, and the environment. Therefore, it is critical to find alternatives for currently available synthetic pesticides.

In this study, the spatial and topical repellent activities of 43 benzoates and certain combinations thereof were evaluated against female Aedes aegypti mosquitoes and their activity compared with that of DEET using both high-throughput in vitro screening tests and arm-in-cage in vivo assays in the laboratory. Three FDA- and EU-approved food additives for human consumption that have been extensively used in foods, drugs, and cosmetics, namely methyl dimethyl anthranilate (MDMA), ethyl 2-methoxybenzoate (E2MOB), and methyl anthranilate (MA), exhibited the most potent spatial repellencies with 30 minute half-repellency dose RD₅₀ values of 6.58, 8.83, and 11.84 μg/cm², respectively in vitro. These RD₅₀ values were significantly more effective than that of DEET at 42.56 μg/cm². A blend of MDMA and ethyl 4-methoxybenzoate (E4MOB) a in 1:1 ratio produced the lowest 30-minute RD₅₀ value of 5.23 μg/cm². One alkyl benzoate, n-butyl benzoate (nBB), elicited powerful knockdown activity in vitro with a 30-minute half-knockdown dose KD₅₀ value of 2.78 μg/cm³. DEET, on the other hand, did not cause half-knockdown within 60 minutes at a dose of 15 μg/cm³. Another FDA- and EU-approved food additive, methyl N-formylanthranilate (MFA), showed decent topical repellency in vivo. Its synthetic analog, n-propyl N-formylanthranilate (nPrFA), demonstrated the most potent topical repellency, followed by its two homologous analogs, ethyl N-formylanthranilate (EFA) and n-butyl N-formylanthranilate (nBFA), with minimum effective dosage (MED) values of 0.0028, 0.0062, and 0.0075 mg/cm², respectively. The MED value of nPrFA is significantly lower than that of DEET at 0.0100 mg/cm². These FDA- and EU-approved food additives that functioned as novel spatial and topical repellents, as well as the knockdown agents, have promising potential to be used in combination with existing mosquito control strategies to enhance the efforts of disease prevention and control. The data presented here offers a new avenue for research on next generation of repellents against blood sucking arthropods.

In this study, two types of benzoates were investigated for topical repellent efficiency against Ae. aegypti: non-substituted and substituted analogs. In the arm-in-cage in vivo assay, non-substituted benzoates did not perform well compared with substituted benzoates. Among substituted benzoates, 4-hydroxy-substituted, trifluoromethyl-substituted, and aminosulfonyl-substituted benzoates did not show significant repellencies at the initial screening dose of 0.187 mg/cm². Some methyl-, methoxy- and chloro-substituted benzoates achieved moderate repellencies. It was found that most of the nitrogen-substituted benzoates provided good topical and spatial repellencies. Some amino-substituted benzoates performed as the best topical and spatial repellents against Ae. aegypti, similar to or significantly better than DEET. Because the vapor pressure of solids is far less than that of liquids, most of the benzoates that were solid state at the room temperature tested in this study did not significantly repel mosquitoes in vivo and in vitro, including M4 MB, M4MOB, M4HB, nPr4HB, nB4HB, M4CB, M2ASB, M4AB, MAcA. However, one anthranilate compound, MFA, is a solid with a low vapor pressure of 0.000013 mmHg at 25.00° C., but it exhibited strong topical repellency in vivo similar to its liquid analog, MDMA, which has vapor pressure value of 0.010000 mmHg at 25.00° C. Both compounds have the same molecular weight at 179, but vapor pressure of MFA is 769 times lower than that of MDMA, indicating that the vapor pressure is not the only factor that affects topical repellency against mosquitos.

The compound MFA is a natural-occurring compound found in leatherwood honey (Rowland, C. Y., et al., 1995, “Comparison of organic extractives found in leatherwood (Eucryphia lucida) honey and leatherwood flowers and leaves,” J. Agric. Food Chem. 43(3): 753-763. It was also detected in wild strawberries (Pyysalo T., et al., 1979, “Volatiles of wild strawberries, Fragaria vesca L., compared to those of cultivated berries, Fragaria ananassa cv. Senga Sengana,” J Agric Food Chem 27:19-22). Due to its grape-like scent and flavor, it is an U.S. Food and Drug Administration (FDA) and Europe Union (EU) approved food additive for human consumption and has been extensively used in food industry (FDA. Code of Federal Regulations Title 21-Food and Drugs. Sec. 172.515 Synthetic Flavoring Substances and Adjuvants, available online; and European-Union, “Food Flavourings,” EU Regulation 1334/2008 and 178/2002, also available online. No adverse effects to humans have been found for this compound (2008, “Flavouring Group Evaluation 84, (FGE.84)[1]—Consideration of Anthranilate derivatives evaluated by JECFA (65^{th} meeting)—Opinion of the Scientific Panel on Food Additives, Flavourings, Processing Aids and Materials in Contact with Food,” European Food Safety Authority—The EFSA Journal 856, 1-24).

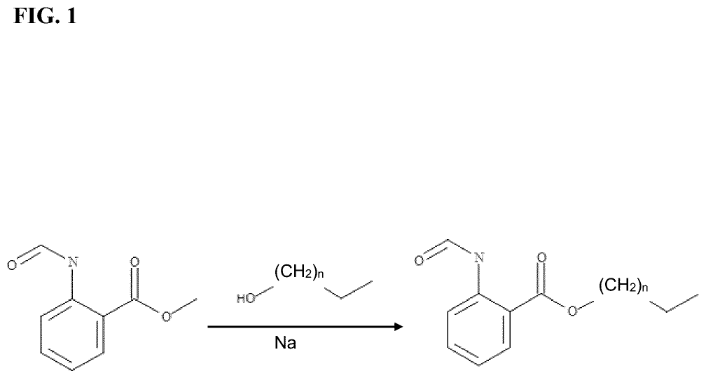

Because MFA is a solid but still exhibits strong topical repellency, the corresponding ethyl, propyl, and butyl analogs were synthesized following the reaction depicted in FIG. 1, to further explore the structure-activity relationship. The chemical structures of the resulting compounds are listed in Table AA. Compound MFA is a methyl ester of the 2-(formylamino)-benzoic acid (also called as N-formylanthranilic acid) while synthetic analogs, EFA, nPrFA, and nBFA, are ethyl, n-propyl, and n-butyl esters. The only differences are in the aliphatic alcohol moieties from a homologous series. Although these analogs have not yet been found in nature, they should possess similar chemical properties to MFA, but with different vapor pressures. It was noted that the ethyl ester of N-formylanthranilic acid, EFA, also was a solid crystal while nPrFA and nBFA were pale-yellow oils at room temperature. Though the EFA is a solid, like MFA, the MED dose established for this analog is much lower than that of MFA and icaridin, indicating that the compounds possessing N-formylanthranilates chemical skeleton are significantly more repellent against of Ae. aegypti. The reason why these two solid N-formylanthranilates exhibit considerable topical repellencies against Ae. Aegypti is unknown. Among these MFA analogs, propyl ester of N-formylanthranilic acid, nPrFA, is the most potent and it is a significantly stronger topical repellent than DEET. Our results demonstrated that substituted benzoates with N-formylanthranilates chemical skeletons are promising topical repellent candidates and can be considered as potential DEET alternatives or complementary tools to protect humans from mosquito bites.

In the high-throughput in vitro screening test, the spatial repellent results were similar to the topical repellent results obtained in the arm-in-cage in vivo assay. Generally speaking, the substituted benzoates demonstrated better repellencies than the non-substituted benzoates. All solid compounds did not show spatial repellencies at the highest dose of 100 μg/cm², including two most potent solid topical repellents MFA and EFA. Not intending to be theory-bound, the reason why these two compounds did not show spatial repellency may be due to the fact that vapor pressure is more critical for spatial repellents than topical repellents. Some benzoates, including M2MOB, M2NB, MA, EA, AA, MMA, and MDMA, which exhibited good topical repellencies in vivo also showed excellent spatial repellencies in vitro. However, some amino substituted benzoates, including E3AB, nBA, nPrFA and nBFA, only demonstrated decent topical repellencies in vivo, but did not show any spatial repellencies in vitro at the highest dose of 100 μg/cm². On the contrary, two methoxyl-substituted compounds, E4MOB and E2MOB, showed excellent spatial repellency in vitro, but did not exhibit topical repellency at the initial screening dose of 0.187 mg/cm² in vivo, indicating that the modes of action of benzoates as topical and spatial repellents may be different for select analogs in this class.

It has been found that one anthranilate benzoate, MDMA, not only exhibited good topical repellency in the arm-in-cage in vivo assay, but also demonstrated the most potent spatial repellency in the high-throughput in vitro screen tests. Although a blend of MDMA with another top spatial repellent, E4MOB, did not produce a statistically significant synergistic effect, it exhibited the smallest half-repellency doses (RD₅₀), lower than that of the individual compounds. The combinations of different decent spatial repellents, including M2NB, E4MOB, E2MOB, MDMA, MA, EA, AA, MMA, MDMA, may be promising effective spatial repellent tools to create a protective space to protect people from the bites of mosquito and other arthropods.

Because of DEET's demonstrated excellence, it has been widely used as repellent. As it is one of the most effective insect repellents at present, it was used as a positive control in the bioassays taught herein. DEET performed very well in the arm-in-cage in vivo assay. It also could consistently repel 100% mosquitoes in 60 minutes with a dose of 100 μg/cm² in the high-throughput in vitro screening test. However, some of the compounds taught herein achieved 100% in vitro repellency in 30 minutes with much lower doses, indicating that these compounds are more efficient spatial repellents than DEET. The results presented here are coincident with previously published findings (Kline, D L, et al., 2003 “Olfactometric evaluation of spatial repellents for Aedes aegypti,” J. Med. Entomol. 40(4):463-467; Bernier, U R, et al., 2005, “Cornparison of contact and spatial repellency of catnip oil and N,N-diethyl-3-methylibenzarnide (deet) against mosquitoes,” J. Med. Entomol. 42(3):306-311; Chauhan, K. R., et aL, 2012, “A field bioassay to evaluate potential spatial repellents against natural mosquito populations,” J. Am. Mosq. Control Assoc. 28(4):301-306). Therefore, application of more efficient spatial repellents that can comprise a successful multi-faceted IPM approach to prevent blood sucking arthropods from entering a space occupied by human hosts is desirable (Norris, E J, et al., 2017 “Future Repellent Technologies: The Potential of Spatial Repellents and Their Place in Mosquito-Borne Disease Control,” Int. J. Environ. Res. Public Health January 29; 14(2):124). Currently, selected pyrethroids/pyrethrins, including allethrin, metofluthrin, transfluthrin, and natural pyrethrins are registered as spatial repellents in the USA by the US Environmental Protection Agency. However, significant pyrethroid-resistance exists and therefore there extended utility may be limited. Many essential oils have been studied as potential DEET alternatives (Mishra P., et al., 2023, “Mosquito repellents derived from plants,” Int. J. Mosq. Res. 10(2): 37-44; Mattos da Silva M R and Ricci Jr E., 2020, “An approach to natural insect repellent formulations: from basic research to technological development,” Acta Tropica 212:105419), but rapid evaporation, shorter lifespans, and some potential dermatological and genotoxic or mutagenic activities by high doses of essential oils are the major restriction of product development for commercialization (Almeida A. R., et al., 2023, “Challenges encountered by natural repellents: Since obtaining until the final product,” Pestic. Biochem. Physiol 195:105538).

Alkyl benzoates usually are non-genotoxic, non-sensitizing, non-comedogenic, non-carcinogenic, and odorless and have been widely used as fragrant fixative ingredients in cosmetics (Becker L C, et al., 2012, “Safety assessment of alkyl benzoates as used in cosmetics,” Int. J. Toxicol. 31 (6 Suppl): 342S-372S; Bordes C, et al., 2021, “Formulation of Pickering emulsions for the development of surfactant-free sunscreen creams,” Int. J. Cosmet. Sci. August; 43(4):432-445). So far, no applications of alkyl benzoates have been found in well-established pest management programs. In the research presented herein, the two alkyl benzoates, nBB and iBB, not only provoked potent knockdown activities from the female Ae. aegypti in the high-throughput in vitro screening test, but also elicited significant nerve block responses from the larvae central nervous system in the neurophysiological study. These results indicate that select molecules within this class are capable of modifying signal delivery in the mosquito nervous system and potentially explain the mode of action for these mosquito repellents. In addition, the application of alkyl benzoates identified in this study, especially nBB, as a knockdown agent and toxicant with other spatial and topical repellents should enhance their efficiency and improve the efficacy of repellent products for mosquito control and disease prevention.

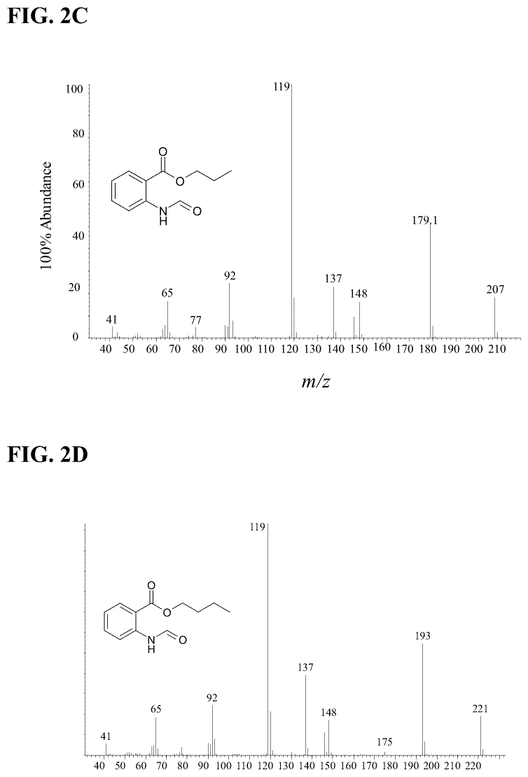

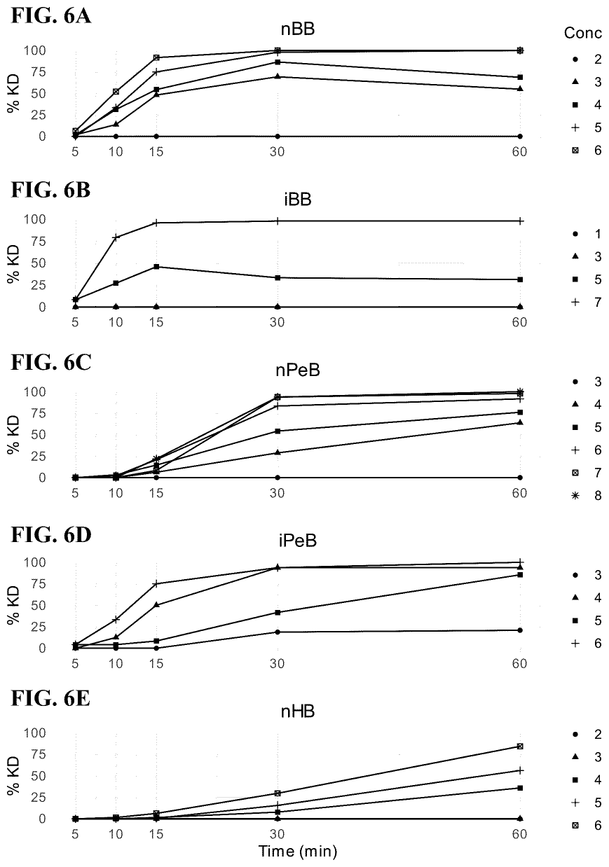

Based on a previous report (Licciardi, S., et al., 2006, “Lethal and behavioural effects of three synthetic repellents (DEET, IR3535, and KBR 3023) on Aedes aegypti mosquitoes in laboratory assays,” Med. Vet. Entomol. 20, 288-293), it was estimated that DEET might begin to cause knockdown at a dose of approximately 15 μg/cm³. However, DEET was incapable of causing half-knockdown at 15 μg/cm³ within 60 minutes in the high-throughput in vitro screening assay taught herein, highlighting the potency of these alkyl benzoates as knockdown agents. Furthermore, as shown in FIG. 6A, FIG. 6B, and FIG. 6D, nBB, iBB, and iPeB began to cause knockdown in as little as 5 minutes. The neurophysiological results shown in Table 2 and FIG. 3 corroborate the findings of the knockdown tests that these alkyl benzoates are fast-acting neurological disruptors to mosquitoes. Of important note is the fact that nBB alone was not significantly more lethal than the blend of nBB:nPeB:nHB (Table 2). This finding indicates that a blend of alkyl benzoates containing two compounds with 30-minutes RD₅₀ values comparable to DEET (as shown in Table 1), is not less lethal than a solution containing nBB alone, despite containing only ⅓ parts nBB.

The most effective spatial and topical repellents reported in this study are natural occurring benzoate compounds. Specifically, the compounds M2MOB, E2MOB, E4MOB, MA, EA, AA, MMA, MDMA, and MFA, are FDA- and EU-approved food additives for human consumption and have been extensively used food, perfumes, and cosmetics industries. They are not harmful to human or animal health or the environment and are ideal candidates for the development of a new generation of spatial and topical repellent products of natural origin, which may not need extensive toxicity tests required by regulatory agencies. Although a blend of E4MOB and MDMA displayed the best spatial repellency, different combinations of promising benzoates at different ratios, as well as combination with the knockdown agents, such as nBB may be further evaluated for optimizing spatial formulations. The MFA homologous analogs, EFA, nPrFA, and nBFA, exhibited excellent topical repellencies in this study. Because they are not FDA- and EU-approved food additives, necessary toxicity studies are needed before further application. To the best of our knowledge, the topical/spatial repellencies of N-formylanthranilates and alkoxy-substituted benzoates of Formula 1, as well as the knockdown property of non-substituted benzoates of Formula 2 reported in this study have not been previously investigated, and their modes of action, target molecules, and interaction with the olfactory and taste receptors of mosquitoes are unknown and need to be further explored.

Overall, it was surprisingly discovered that certain nitrogen- and alkoxyl-substituted alkyl benzoates compounds possessed potent topical and spatial repellencies, as well as the knockdown property of non-substituted benzoates against female Ae. aegypti. Therefore, compounds with some/all of these three chemical structural formulas have high potential to be used as the models for further development of novel alternatives or complementary tools to currently used repellents on the market for 1) topical applications on human skin to reduce the bites of mosquitoes and other blood-sucking arthropods; 2) spatial applications to create a space to prevent biting by blood-sucking arthropods thereby reducing the potential disease transmission. The discoveries presented herein offer a new avenue for research on the continual development of next-generation repellents.

The amount of the compounds or compositions described herein to be used will be at least an effective amount. The term “effective amount,” as used herein, means the minimum amount of the compounds or compositions needed to repel, knockdown, and/or kill a treated blood-sucking arthropod when compared to blood sucking arthropods in a same area or object which is untreated. The blood-sucking arthropods may be insects, ticks, mites, spiders, centipedes, scorpions, chiggers, solifugids, or the like. Of course, the precise amount needed will vary in accordance with the particular composition used; the type of area or object to be treated; and the environment in which the area or object is located. The precise amount of the composition can easily be determined by one skilled in the art given the teachings of this application. For example, one skilled in the art could follow the procedures utilized below; the composition would be statistically significant in comparison to a negative control. The compounds described herein, or the compositions described herein to be used will be at least an effective amount of the compound or diluted solution of the compound; for fumigation the compounds used may have to be pure form (not mixed or adulterated with any other substance or material). Generally, the concentration of the compounds may be, but not limited to, from about 0.025% to about 30% in a solution, the concentration of the compounds may be from about 0.5% to about 4%, from about 1% to about 2%. The composition may or may not contain a control agent for arthropods, such as a biological control agent or an insecticide known in the art to repel, knockdown, or kill blood-sucking arthropods. Other compounds, such as attractants or other agents known in the art) may be added to the composition provided they do not substantially interfere with the intended activity and efficacy of the composition; whether or not a compound interferes with activity and/or efficacy can be determined, for example, by the procedures utilized below.

The composition of the invention may comprise at least one solvent or diluent. Solvents or diluents useful in the compositions of the invention are aromatic hydrocarbons, such as xylene, toluene, or alkylnaphthalenes, chlorinated aromatic or chlorinated aliphatic hydrocarbons, such as chlorobenzene, chloroethylene, or methylene chloride, aliphatic hydrocarbons, such as pentane, hexane, heptane, octane, cyclohexane, paraffins, petroleum fractions, mineral and vegetable oils, alcohols, such as methanol, ethanol, isopropanol, butanol or glycol and their ethers and esters, ketones such as acetone, methyl ethyl ketone, methyl isobutyl ketone or cyclohexanone, strongly polar solvents, such as dimethyl sulphoxide, carbonates such as propylene carbonate, butylene carbonate, diethyl carbonate or dibutyl carbonate, nitriles such as acetonitrile or propanenitrile, and also water.

The compositions described herein can therefore be used for repelling, knocking down, and/or killing blood-sucking arthropods such as mosquitoes (for example Aedes, Culex and Anopheles species), sand flies (for example Phlebotomus and Lutzomyia species such as Phlebotomus papatasi), owl gnats (Phlebotoma), blackflies (Culicoides species), buffalo gnats (Simulium species), biting flies (for example Stomoxys calcitrans), tsetse flies (Glossina species), horseflies (Tabanus, Haematopota and Chrysops species), house flies (for example Musca domestica and Fannia canicularis), meat flies (for example Sarcophaga carnaria), flies which cause myiasis (for example Lucilia cuprina, Chrysomyia chloropyga, Hypoderma bovis, Hypoderma lineatum, Dermatobia hominis, Oestrus ovis, Gasterophilus intestinalis and Cochliomyia hominovorax), bugs (for example Cimex lectularius, Rhodnius prolixus and Triatoma infestans), lice (for example Pediculus humanus, Haematopinus suis and Damalina ovis), louse flies (for example Melaphagus orinus), fleas (for example Pulex irritans, Cthenocephalides canis and Xenopsylla cheopis), sand fleas (for example Dermatophilus penetrans), stable flies, Culicoides (biting midges), and other major agricultural pests.

The compositions described herein can therefore be used for repelling, knocking down, and/or killing blood-sucking arthropods such as harmful or troublesome blood-sucking, stinging and biting insects, ticks and mites. The terms “insects” and “arthropods” as used herein include all stages of an insect or arthropod life cycle such as adults, larvae, nymphs, pupae, and eggs. The term “arthropods” as used herein includes insects and non-insects such as ticks, mites, spiders, centipedes, scorpions, chiggers, and solifugids.

Ticks include, for example, Ornithodorus moubata, Ixodes inimum, Boophilus microplus and Amblyomma hebreum, and mites include, for example, Varroa destructor, Sarcoptes scabiei, Dermanyssus gallinae, Tetranychus urticae, Tetranychus cinnabarinus, and Oligonychus pratensis.

Spiders include, for example, Lactrodectus mactans, Loxosceles recluse, Tegenaria agrestis (Walckenaer), Achaearanea tepidariorum, Salticidae, Pholcus phalangioides, and Lycosa.

Centipedes include, for example, Scutigera coleoptrata. Scorpions include, for example, Centruroides exilicauda, Centruroides vittatus, Hadrurus arizonensis, and Solifugae. Solifugids include, for example, Solifugae.

The blood-sucking and biting arthropods include insects, ticks, and mites, which include mosquitoes, sand flies, biting flies (e.g., black flies, biting midges), bed bugs, ticks, and fire ants (genus Solenopsis; for example, black imported fire ants, S. richetri).

As used herein, the term “about” refers to a quantity, level, value, or amount that varies by as much as 10% to a reference quantity, level, value, or amount. For example, about 1.0 g means 0.9 g to 1.1 g and all values within that range, whether specifically stated or not.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

Mention of trade names or commercial products in this disclosure is solely for the purpose of providing specific information and does not imply recommendation or endorsement by the U.S. Department of Agriculture.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

In an embodiment, the disclosure relates to a blood-sucking arthropod-repelling, knocking down, and/or killing composition comprising a solvent or diluent and a compound of Formula 1 or Formula 2:

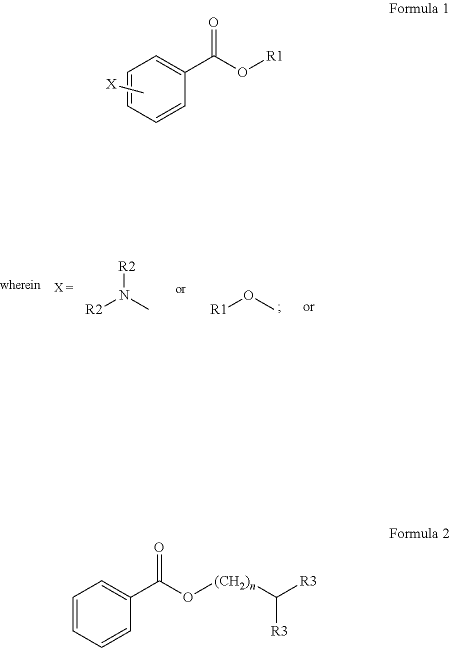

where n is 1, 2, 3, or 4; R1 are independently an alkyl or alkenyl group; R2 are independently hydrogen, oxygen, aldehyde, ketone, acetyl, alkyl, or alkenyl group; and R3 are independently hydrogen, halogen, or CH₃ groups. In some embodiments of the disclosure, the composition comprises at least two compounds of Formula 1, Formula 2, or a combination thereof.

In some embodiments, the disclosure relates to a blood-sucking arthropod-repelling composition and comprises a compound of Formula 1

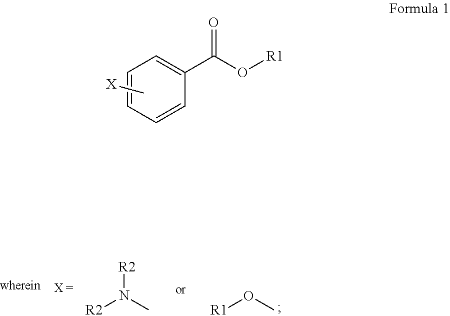

R1 are independently an alkyl or alkenyl group; and R2 are independently hydrogen, oxygen, aldehyde, ketone, acetyl, alkyl, or alkenyl groups.

In some embodiments, the disclosure relates to a blood-sucking arthropod-knocking-down composition and comprises a compound of Formula 2

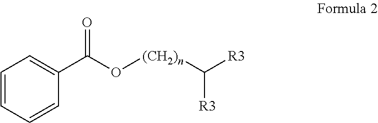

where n is 1, 2, 3, or 4; and R3 are independently hydrogen, halogen, or CH₃ groups.

In some embodiments of the disclosure, the composition comprises at least one of methyl benzoate (MB), ethyl benzoate (EB), vinyl benzoate (VB), n-propyl benzoate (nPrB), n-butyl benzoate (nBB), benzyl benzoate (BB), methyl 2-chlorobenzoate (M2CB), methyl 2-nitrobenzoate (M2NB), iso-butyl benzoate (iBB), n-pentyl benzoate (nPeB), n-hexyl benzoate (nHB), methyl 3-methylbenzoate (M3 MB), iso-pentyl benzoate (also called iso-amyl benzoate) (iPeB), iso-propyl benzoate (iPrB), methyl 2-methoxybenzoate (M2MOB), ethyl 2-methoxybenzoate (E2MOB), ethyl 4-methoxybenzoate (E4MOB), methyl anthranilate (MA), n-butyl anthranilate (nBA), methyl 3-nitrobenzoate (M3NB), methyl 4-nitrobenzoate (M4NB), ethyl 3-aminobenzoate (E3AB), allyl anthranilate (AA), methyl 2-methylbenzoate (M2 MB), methyl 3-methoxybenzoate (M3MOB), ethyl anthranilate (EA), methyl N-methylanthranilate (MMA), methyl N,N-dimethylanthranilate (MDMA), iso-butyl anthranilate (iBA), methyl N-acetylanthranilate (MAcA), methyl N-formylanthranilate (MFA), ethyl N-formylanthranilate (EFA), n-Propyl N-formylanthranilate (nPrFA), or n-Butyl N-formylanthranilate (nBFA).

In some embodiments of the disclosure, the composition comprises a blend of at least two of MB, EB, VB, nPrB, nBB, BB, M2CB, M2NB, iBB, nPeB, nHB, M3 MB, iPeB, iPrB, M2MOB, E2MOB, E4MOB, MA, M2ASB, BA, M3NB, M4NB, E3AB, AA, M2 MB, M3MOB, EA, MMA, MDMA, iBA, MAcA, MFA, EFA, nPrFA, nBFA, or a combination thereof. In some embodiments of the disclosure, the compounds in the composition blends are present in the same ratios. In some embodiments of the disclosure, the compounds in the composition blends are present in different ratios.

In an embodiment, the disclosure relates to a method for repelling, knocking down, and/or killing blood-sucking arthropods, the method comprising treating an object or area in need thereof with an effective amount of arthropod-repelling, knocking down, and/or killing composition comprising at least one compound of Formula 1 or Formula 2. In some embodiments of the disclosure, the method for repelling, knocking down, and/or killing blood-sucking arthropods, comprises treating an object or area in need thereof with an effective amount of arthropod-repelling, knocking down, and/or killing composition comprising at least two compounds of Formula 1, Formula 2, or a mixture thereof. In some embodiments of the disclosure, the method for repelling blood-sucking arthropods comprises treating an object or area in need thereof with an effective amount of arthropod-repelling composition of Formula 1. In some embodiments of the disclosure, the method for knocking down blood-sucking arthropods comprises treating an object or area in need thereof with an effective amount of arthropod-knocking down composition of Formula 2. In some embodiments of the disclosure, the blood-sucking arthropods in the method for repelling, knocking down, and/or killing blood-sucking arthropods are mosquitoes, sandflies, flies, tabanids, lice, sheep ked, fleas, ticks, mites, spiders, centipedes, scorpions, or chiggers. In some embodiments of the disclosure, the blood-sucking arthropods to be repelled, knocked down, and/or killed are adults, larvae, nymphs, pupae, or eggs.

In some embodiments of the disclosure, the composition for repelling, knocking down, and/or killing blood-sucking arthropods comprises at least one of MB, EB, VB, nPrB, nBB, BB, M2CB, M2NB, iBB, nPeB, nHB, M3 MB, iPeB, iPrB, M2MOB, E2MOB, E4MOB, MA, M2ASB, BA, M3NB, M4NB, E3AB, AA, M2 MB, M3MOB, EA, MMA, MDMA, iBA, MAcA, MFA, EFA, nPrFA, or nBFA. In some embodiments of the disclosure, the composition for repelling, knocking down, and/or killing blood-sucking arthropods comprises a blend of at least two of MB, EB, VB, nPrB, nBB, BB, M2CB, M2NB, iBB, nPeB, nHB, M3 MB, iPeB, iPrB, M2MOB, E2MOB, E4MOB, MA, M2ASB, BA, M3NB, M4NB, E3AB, AA, M2 MB, M3MOB, EA, MMA, MDMA, iBA, MAcA, MFA, EFA, nPrFA, nBFA, or a mixture thereof.

In an embodiment, the disclosure relates to a kit for repelling, knocking down, and/or killing blood-sucking arthropods, the kit comprising a solvent or diluent and a compound of Formula 1 or Formula 2. In some embodiments of the disclosure, the kit is for repelling blood-sucking arthropods, and comprises a compound of Formula 1. In some embodiments of the disclosure, the kit is for knocking down blood-sucking arthropods, and comprises a compound of Formula 2. In some embodiments of the invention, the kit for repelling, knocking down, and/or killing blood-sucking arthropods comprises at least one of MB, EB, VB, nPrB, nBB, BB, M2CB, M2NB, iBB, nPeB, nHB, M3 MB, iPeB, iPrB, M2MOB, E2MOB, E4MOB, MA, M2ASB, BA, M3NB, M4NB, E3AB, AA, M2 MB, M3MOB, EA, MMA, MDMA, iBA, MAcA, MFA, EFA, nPrFA, nBFA. In some embodiments of the disclosure, the kit for repelling, knocking down, and/or killing blood-sucking arthropods comprises a blend of at least two of MB, EB, VB, nPrB, nBB, BB, M2CB, M2NB, iBB, nPeB, nHB, M3 MB, iPeB, iPrB, M2MOB, E2MOB, E4MOB, MA, M2ASB, BA, M3NB, M4NB, E3AB, AA, M2 MB, M3MOB, EA, MMA, MDMA, iBA, MAcA, MFA, EFA, nPrFA, nBFA, or a mixture thereof.

In an embodiment, the disclosure relates to a compound of Formula 1

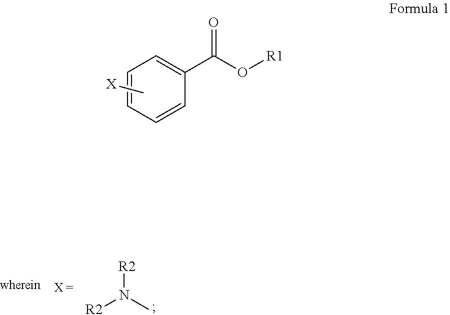

R1 is an alkyl or alkenyl group; and
R2 are independently hydrogen, oxygen, aldehyde, ketone, acetyl, alkyl, or alkenyl groups; and
   wherein the compound is EFA, nPrFA, or nBFA.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

### Materials and Methods

The materials and methods used to prepare the compounds of the invention and determine their effect on blood-sucking arthropods are listed in this example.

Ae. aegypti eggs were obtained from the Center for Medical and Veterinary Entomology, USDA, ARS in Gainesville, FL. Larvae were reared in a Percival environmental chamber (Percival Scientific, Inc, Perry, Iowa, USA) at 27° C., 70% humidity, with a 12:12 L:D photoperiod. Larvae were fed ground Tetramin® fish food (Spectrum Brand Pet, LLC, Blacksburg, Virginia, USA). Upon emergence, adult mosquitoes were fed a 10% sucrose solution and maintained under the same conditions as were the larvae.

Benzoate compounds for the studies were purchased from four different companies. Methyl benzoate (MB), CAS Number 93-58-3, ≥99% purity; ethyl benzoate (EB), CAS Number: 93-89-0, natural, ≥99% purity, FCC, FG; vinyl benzoate (VB), CAS Number: 769-78-8, ≥99% purity; n-propyl benzoate (nPrB), CAS Number: 2315-68-6, 99% purity; n-butyl benzoate (nBB), CAS Number: 136-60-7, 99% purity; benzyl benzoate (BB), CAS Number: 120-51-4, natural, ≥99% purity, FCC, FG; methyl 2-chlorobenzoate (M2CB), CAS Number: 610-96-8, ≥98% purity; methyl 2-nitrobenzoate (M2NB), CAS Number: 606-27-9, 98% purity; N, N-Diethyl-meta-toluamide (DEET), CAS Number: 134-62-3, 97% purity; phenyl benzoate (PhB), CAS Number 93-99-2, ≥99% purity; phenethyl benzoate (PhEB), CAS Number 94-47-3, ≥98% purity; methyl 4-methylbenzoate (M4 MB), CAS Number 99-75-2, ≥99% purity; methyl 2-methoxybenzoate (M2MOB), CAS Number 606-45-1, ≥99% purity; methyl 4-methoxybenzoate (M4MOB), CAS Number 121-98-2, ≥99% purity; methyl 4-hyhroxylbenzoate (M4HB), CAS Number 99-76-3, ≥99% purity; n-propyl 4-hydroxylbenzoate (nPr4HB), CAS Number 94-13-3, ≥99% purity; n-butyl 4-hydroxybenzoate, (nB4HB), CAS Number 94-26-8, ≥99% purity; methyl 4-chlorobenzoate (M4CB), CAS Number 1126-46-1, ≥99% purity; methyl 4-(trifluoromethyl)benzoate (M4tFMB), CAS Number 2967-66-0, ≥99% purity; methyl 2-(aminosulfonyl)benzoate (M2ASB), CAS Number 57683-71-3, ≥98% purity; methyl anthranilate (MA), CAS Number 134-23-3, ≥98% purity; methyl 4-aminobenzoate (M4AB), CAS Number 619-45-4, ≥98% purity; ethyl anthranilate (EA), CAS Number 87-25-2, ≥98% purity; ethyl 3-aminobenzoate (E3AB), CAS Number 582-33-2, ≥98% purity; allyl anthranilate (AA), CAS Number 7493-63-2, ≥98% purity; methyl N-methylanthranilate (MMA), CAS Number 85-91-6, ≥98% purity; methyl N-acetylanthranilate (MAcA), CAS Number 2719-08-6, ≥99% purity; methyl N-formylanthranilate (MFA), CAS Number 41270-80-8, ≥98% purity; and sodium, CAS Number 7740-23-5, ≥99% purity, were purchased from Sigma-Aldrich (St. Louis, Missouri, USA). The compounds iso-butyl benzoate (iBB), CAS Number 120-50-3, ≥98% purity; n-pentyl benzoate (nPeB), CAS Number: 2049-96-9, ≥98% purity; and n-hexyl benzoate (nHB), CAS Number: 6789-88-4, ≥98% purity, were purchased from Alfa Aesar (Tewksbury, Massachusetts, USA). The compounds methyl 3-methylbenzoate (M3 MB), CAS Number: 99-36-5, 97% purity; iso-propyl benzoate (iPrB), CAS Number 939-48-0, ≥99.0% purity; ethyl 4-methoxybenzoate (E4MOB), CAS Number 94-30-4, ≥99% purity; n-butyl anthranilate (nBA), CAS Number 7756-96-9, ≥98% purity; ethyl 2-methoxybenzoate (E2MOB), 7335-26-4, ≥98% purity; and methyl N,N-dimethyl anthranilate (MDMA), CAS Number 10072-05-6, ≥97% purity, were purchased from TCI America (Portland, Oregon, USA). The compound iso-pentyl benzoate (also called iso-amyl benzoate) (iPeB), CAS No: 94-46-2, 99% purity, was purchased from EMD Millipore Corporation (Billerica, Massachusetts, USA). The compound methyl 2-methylbenzoate (M2 MB), CAS Number 89-71-4, ≥98% purity, was purchased from VWR (Swedesboro, New Jersey, USA). The compound methyl 3-methoxybenzoate (M3MOB), CAS Number 5-81-0, ≥98% purity, was purchased from Thermo Fisher Scientific (Waltham, Massachusetts, USA). The inimum iso-butyl anthranilate (iBA), CAS Number 7779-77-3, 98% purity, was purchased from Santa Cruz Biotechnology, Inc. (Dallas, Texas, USA). Acetone, CAS Number 67-64-1, ≥99.5% purity; anhydrous 1-propanol, CAS Number 71-23-8, ≥99.7% purity; and anhydrous 1-butanol, CAS Number 71-36-3, ≥99.8% purity, were used as solvents and purchased from Sigma-Aldrich (St. Louis, Missouri, USA). Anhydrous ethanol, CAS Number 64-17-5, ≥99.5% purity was acquired from the Warner-Graham Company (Cockeysville, Maryland, USA). All chemicals were used without further purification in the Beltsville laboratory. They were coded and sent to the USDA-Center for Medical, Agricultural & Veterinary Entomology, Gainesville, Florida for blind arm-in-cage in vivo assays.

GC-MS Analyses. After transesterification, the resulting products were analyzed by GC-MS following Zhang A., et al. (2004, “Sex pheromone of the pink hibiscus mealybug, Maconellicoccus hirsutus, contains an unusual cyclobutanoid monoterpene,” Proc. Natl. Acad. Sci. USA 101(26):9601-9606). Briefly, an Agilent 8890 GC system equipped with a 5977 Inert Plus Turbo Mass Selective Detector (MSD) in electron ionization (EI) mode, coupled to a HP-5MS (60 m×0.25-mm i.d., 0.25-μm film-thickness, Agilent J&W, Santa Clara, California, USA), with helium as carrier (2.0 mL/min) was used. The oven temperature n was started at 40° C. for 5 minutes, then programmed to rise to 280° C. at 15° C./minute and held for 5 minutes in the splitless mode, 70-eV electron beam was employed for sample ionization

### Example 2

### Chemical Synthesis of Methyl N-formylantranylate Analogs

Formylanthranilate analogs, Ethyl N-formylanthranilate, Propyl N-formylanthranilate, and propyl N-formylanthranilate, were prepared using transesterification.

Ethyl N-formylanthranilate. The anthranilate analogs were prepared via transesterification using the following modified method. A two neck 100 mL round bottom flask fitted with nitrogen line, reflux condenser, and magnetic stirrer bar was flame dried. Once cooled and with nitrogen flowing, the system was charged with the starting material (methyl N-formylanthranilate, 1.004 g, 5.60 mmol), anhydrous ethanol (50 mL), and the base solutions, which were prepared by allowing a freshly cut portion of sodium to react with the anhydrous alcohols (5 mg Na in 10 mL ethanol). The mixture was refluxed with stirring until the starting material was no longer evident via TLC and then the solvent was removed under reduced pressure. The crude materials (1.33 g ethyl analog) were purified via flash chromatography (silica gel 60, EM Science, 230-400 mesh) using a mixture of hexanes and ethyl acetate in a 6:1 ratio. The appropriate cuts were combined and stripped of solvent under reduced pressure to obtain 0.846 g ethyl N-formylanthranilate (4.38 mmol, pale-yellow crystal) in 78% yield. EI-MS m/z (%): 193 [M]⁺ (18), 165 (50), 148 (11), 146 (9), 137 (5), 119 (100), 92 (26), 65 (16).

Propyl N-formylanthranilate. The same procedure was used for preparing ethyl N-formylanthranilate. Only difference was that the mixture was stirred at RT until the starting material was no longer evident. Anhydrous 1-propanol (50 mL), 5 mg Na in 10 mL 1-propanol, crude propyl analog (1.38 g), 1.05 g propyl N-formylanthranilate (5.06 mmol, pale-yellow oil) in 90% yield. EI-MS m/z (%): 207 [M]⁺ (16), 179 (46), 148 (14), 146 (8), 137 (20), 119 (100), 92 (21), 77 (4), 65 (15), (41 (4).

Butyl N-formylanthranilate. The same procedure was used for preparing propyl N-formylanthranilate. Anhydrous 1-butanol (50 mL), 16 mg Na in 10 mL 1-butanol, crud butyl analog (1.41 g), butyl analog, 1.178 g butyl N-formylanthranilate (5.33 mmol, while oil) in 88% yield. EI-MS m/z (%): 221 [M]+(14), 193 (42), 148 (14), 146 (8), 137 (35), 119 (100), 92 (20), 77 (4), 65 (15), 41 (5).

TABLE AA
lists the compounds tested

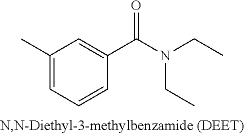

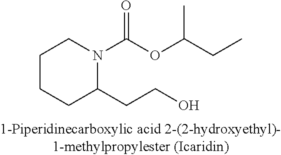 [SMILES: CCC(C)OC(=O)N1CCCCC1CCO]

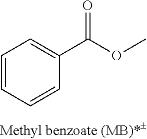

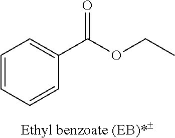

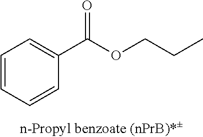

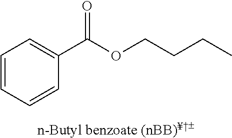

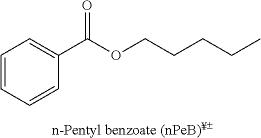

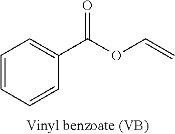

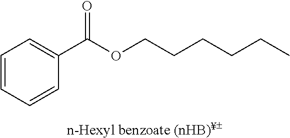

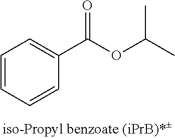

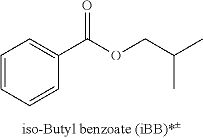

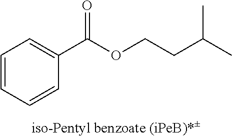

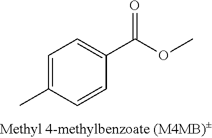

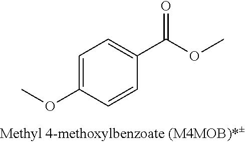

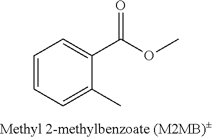

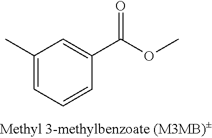

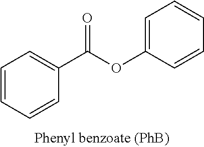 [SMILES: O=C(Oc1ccccc1)c1ccccc1]

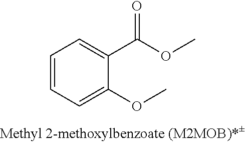

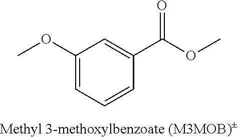

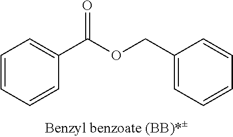 [SMILES: O=C(OCc1ccccc1)c1ccccc1]

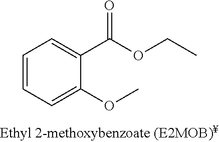

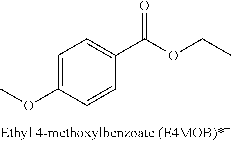

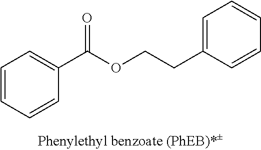 [SMILES: O=C(OCCc1ccccc1)c1ccccc1]

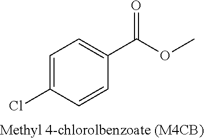

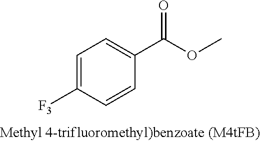

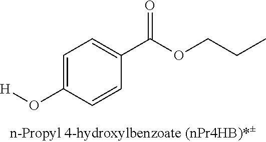

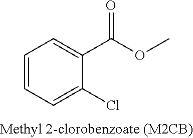

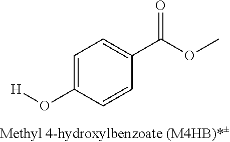

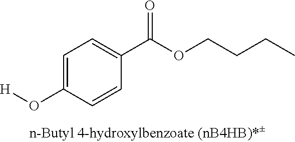

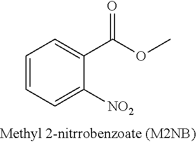

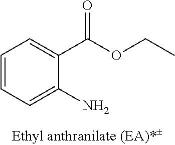

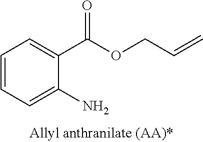

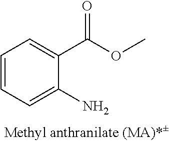

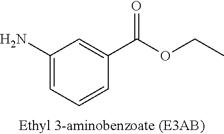

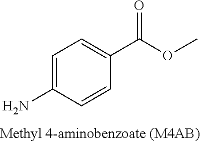

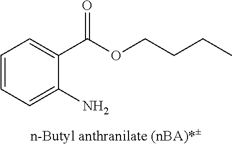

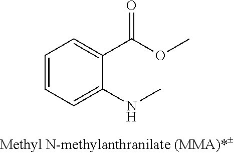

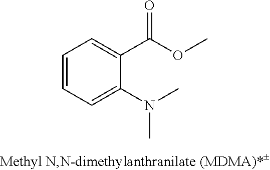

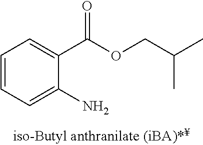

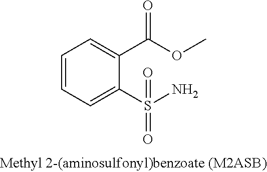

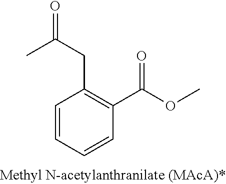

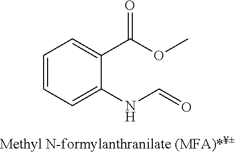

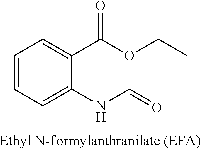

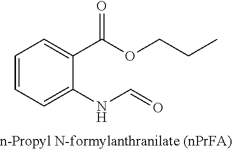

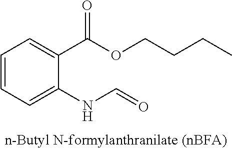 [SMILES: CCCCOC(=O)c1ccccc1NC=O]

*FDA-approved food flavoring agent or adjuvant
^{†}FDA-approved indirect food additive
^{¥}EU-approved food flavoring agent or adjuvant
^{±}Natural product
Abbreviations of compounds with no superscript symbols
are synthetic compounds and have not been found in nature
up to now.

### Example 3

### In Vitro and In Vivo Assays

In vitro and in vivo studies were performed to understand the ability of the candidate compounds to repel, knockdown, and/or kill blood-sucking arthropods,

Arm-in-Cage Test Cloth-Patch in vivo Assay Pyrethroid-susceptible yellow fever mosquitoes Ae. aegypti (Orlando strain) were reared in the United States Department of Agriculture Mosquito and Fly Research Unit in Gainesville, FL under standard protocols. Three to seven-day-old, starved female mosquitoes were collected using a “draw box” (Posey, K. and Schreck, C. E, 1981, “An airflow apparatus for selecting female mosquitoes for use in repellent and attraction studies” Mosquito News 41: 566-568; US. Department of Agriculture, 1977, Repellent activity of compounds submitted by Walter Reed Army Institute of Research. Part 1. Protection time and minimum effective dosage against Aedes aegypti mosquitoes. Tech. Bull. No. 1549) and were placed in cages at an approximate density 200 mosquitoes/cage. Repellency was determined according to a standard protocol (Bernier, U. R., et al, 2022. “Evaluation and application of repellent-treated uniform/clothing and textiles against vector mosquitoes,” In Advances in Arthropod Repellents (pp. 69-94). Academic Press) and reported as the minimum effective dosage (MED). The MED is the lowest dosage that resulted in five or fewer bites through a repellent-treated cloth during a 1-minute exposure period. A nylon leg stocking was placed over the arm to prevent direct contact of the repellent-treated cloth patch with the skin. Stock solutions of standard repellents, N,N-diethyl-meta-toluamide (DEET) and 1-(1-Methylpropoxycarbonyl)-2-(2-hydroxyethyl)piperidine (icaridin), and candidate compounds were dissolved in acetone in a 2-dram vial with a starting concentration that would yield a final concentration of 0.187 mg/cm² if 1 ml, was applied to the fabric. This concentration is typically about 20-30 times higher than that of MED for DEET. Two-fold serial dilutions of the stock solutions were made in acetone to produce various treatment dosages that ranged from 0,187 to 0.0025 mg/cm² when applied to muslin cloth. Cloth was treated by placing a rolled bandage (50 cm²) into each vial containing 1 mL of solution and allowing the patch to absorb the solution completely. The cloth was taped over a 4 by 9-cm opening cut into a vinyl plastic sheet that was draped around the volunteers' arms and taped in place. The cloth was air-dried approximately 15 min before conducting each test. The work reported here is an average of the MED for at least three volunteers. Each volunteer covered his or her arm with a nylon stocking to avoid contact between the skin and the treated cloth and wore a rubber glove to prevent mosquito bites on the hand.

Candidate compounds were applied on muslin cloth patches at a starting concentration of 0.187 mg/cm² or lower, with concentrations decreasing in 2-fold steps until failure was achieved (more than 5 bites for a particular subject/concentration/compound). For compounds that were effective at doses lower than 0.187 mg/cm² on at least one test subject, the concentration was decreased on other subjects until a minimum effective dose was established for each participant in the study. The minimum effective dose (MED) was determined for each repellent and subject, defined as the lowest concentration that prevents biting). MEDs from each subject were pooled and reported as the average among all replicates/subjects with SEM. A minimum of 3 replicates were performed on at least three human subjects. Written informed consent was obtained for all human subjects used in this study in accordance with IRB protocol #20193320, as approved by the WCG™ IRB.

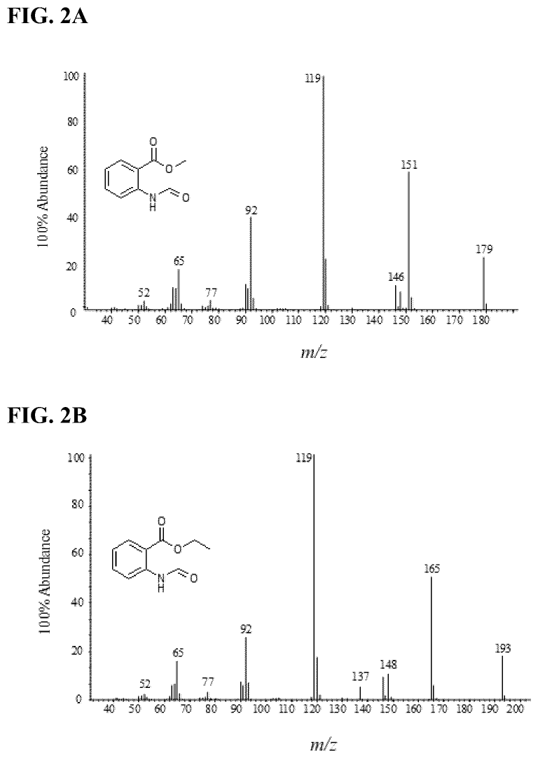

Neurophysiological Experiment—Action on Mosquito Central Nervous System All compounds were screened at 100 μM on the central nervous system of 4^{th} instar Aedes aegypti larvae. Nerve firing was reported as the percentage firing compared to a pre-application baseline period that was determined approximately 3 minutes prior to drug application, similar to methods outlined in Norris, E. J. and Bloomquist J. R. (2021, “Recording central neurophysiological output from mosquito larvae for neuropharmacological and insecticide resistance studies,” J. Insect Physiol. 135: 104319). Nerve block was produced by all compounds screened at this concentration, except for compound nPeB. Compound potency was characterized by “time-to-nerve block” defined as the first time point where significant nerve block was observed compared to the vehicle control via a Student T-test, p<0.05 as shown in Table 1 and FIG. 2.

A high-throughput screening method for evaluating spatial repellency and vapor toxicity, described by Jiang S., et al. (2019, “High-Throughput Screening Method for Evaluating Spatial Repellency and Vapour Toxicity to Mosquitoes,” Med. Vet. Entomol. 33: 388-396), was used for this study. As shown in FIG. 2 of Jiang S., et al., assay tubes were constructed by covering 12.5 cm glass tubes on one side with netting secured by a rubber band. The tubes were used in horizontal orientation. Adult mosquitos 2-7 days old were anesthetized on ice for approximately 5 minutes and 16 females were transferred to each tube. The other end of the tube was then closed with netting and a rubber band.

The conical ends of 50 mL centrifuge tubes (Eppendorf, Enfield, Connecticut, USA) were cut at approximately the 10 mL mark to create the end caps for the assay tubes. Round filter papers, Whatman Grade 1, 2.5 cm in diameter (GE Healthcare, Chicago, Illinois, USA), were placed on a flat glass dish such that they did not overlap, and were treated with 50 μL acetone solution containing a dissolved compound of interest. For repellency tests, filter papers for the “untreated” side of the assay tube received pure acetone, whereas filter papers for the “treated” side received acetone solution containing a dissolved compound of interest. For knockdown tests, both filter papers were treated with acetone solution containing one or more compounds of interest. Acetone on both filter papers served as negative controls.

For repellency assays, filter papers were given 10 minutes of evaporation time before being placed into the end caps with forceps (Jiang S., et al. 2019, Supra). For knockdown assays, filter papers were given 5 minutes of evaporation time before being placed into the end caps. Preliminary testing showed that 50 μL of acetone completely evaporated within 5 minutes. Assay tubes were capped such that the cap securely overlapped the glass but approximately 5 mm of space was left between the netting and the filter paper so that the mosquitos could not contact the filter paper.

Assay tubes were placed on a white polystyrene platform with wooden sticks glued flatly across it to prevent the tubes from rolling. A straight black line was drawn down the center of the platform and assay tubes were centered on the line at the beginning of the tests. In repellency assays, data were collected at 15, 30, and 60 minutes after the end caps were placed on the assay tubes. Assay tubes were not disturbed for the entire 60 minutes. At each time point, the number of mosquitos that remained on the treated side was visually assessed and recorded. The treated side was alternated with each set of tests. For repellency tests, DEET at a dose of 100 μg/cm² served as the positive control.

The observation that nBB caused extensive KD at relatively low concentrations led to direct investigation of this property and examination of whether the KD effects were transient or lethal. For knockdown tests, data were collected at 5, 10, 15, 30, 60, 120 minutes, and mortality was assessed after 24 hours. Mosquitos displaying aberrant posture such as flipping onto their sides or backs were considered knocked down. Occasionally, mosquitos would be immobilized but still dorsal side up, so tubes were gently agitated to determine whether those individuals were knocked down, but this was kept to a minimum. All parts of the assay tubes were washed with 1% ALCONOX detergent (Alconox, Inc.; New York, New York, USA) solution and rinsed with acetone after the tests. Netting was replaced frequently.

Statistical Analyses: Student's T-test was used to compare the means between tested compound and DEET and Icaridin in the arm-in-cage in vivo assay and neurophysiological study. Compounds that were not significantly different from DEET or Icaridin were reported as repellent as either/both these compounds, respectively.

For the high-throughput in vitro screening assays, analyses were conducted with R version 4.2.2 statistical software (R Core Team, 2022, “R: a language and environment for statistical computing. R foundation for statistical computing,” Vienna, Austria). Concentrations were calculated in terms of filter paper surface area (μg/cm²) for repellency assays and in terms of assay tube volume (μg/cm³) for knockdown assays. If a repellency assay resulted in any knockdown, it was not included in the analyses. α=0.05 for all analyses.

Half-repellent (RD₅₀), half-knockdown (KD₅₀), and half-lethal (LD₅₀) doses were calculated from dose-response curves (DRCs) obtained by four-parameter log-logistic equation models generated using the drc package (Dose Response Curve Analyses Software; Ritz C. et al., 2015, “Dose-response analysis using R,” PLOS ONE 10: e0146021). For repellency test analysis, the upper and lower asymptotes for the proportion of mosquitos remaining on the treated side were fixed at 0.5 and 0, respectively. For KD and mortality test analysis, the upper and lower asymptotes for the proportion of mosquitos knocked down or killed were fixed at 1.0 and 0, respectively. To determine whether RD₅₀, KD₅₀, or LD₅₀ values differed across compounds at each timepoint, a joint model assuming different values for each compound and a null model that assumed a single value for all compounds were compared with a likelihood ratio test.

### Example 4

### Results

Topical (contact) repellency evaluation As seen in Table 1 below, of 41 coded benzoate analogs assayed in the arm-in-cage in vivo assay, 21 analogs (MB, EB, VB, iPrB, iBB, nPeB, iPeB, nHB, PhB, BB, PhEB, M4 MB, M4MOB, E4MOB, M4HB, nPr4HB, nB4HB, M4CB, M4tFMB, M2ASB, and M4AB) did not show any topical repellencies at the initial screening dose of 0.187 mg/cm². Seven analogs (nPrB, nBB, M2 MB, M3 MB, M3MOB, M2CB, and MAcA) demonstrated repellency at doses lower than 0.187 mg/cm² on at least one test subject, and were further tested with increased doses on other subjects until the MED values were established. Of the remaining 13 compounds, 2 compounds, nBA and MMA, displayed MED values that were three times lower than the initial dose (MED 0.66 and 0.63 mg/cm², respectively). In addition, 6 compounds, M2MOB, EA, E3AB, AA, MDMA, and MFA, possessed MED values four-to-five times lower than the initial dose (MED 0.049, 0.037, 0.039, 0.039, 0.039, and 0.047 mg/cm²). Moreover, 2 compounds, M2NB and MA, were seven-to-eight times lower than the initial dose (DEM 0.025 and 0.027 mg/cm²), which is similar to DEET and Icaridin. Furthermore, three MFA analogs, EFA, nPrFA, and nBFA (molecular weights of 193, 207, and 221, respectively), demonstrated incredible mosquito repellencies. Compounds nBFA and EFA exhibited repellencies at the 25 and 30 times lower (MED 0.0075 and 0.0062 mg/cm²) while compound nPrFA revealed repellency at 64 times lower (MED 0.0028 mg/cm²) than the initial screening dose of 0.187 mg/cm² applied, which was significantly more effective than that of DEET (MED 0.0100±0.003 mg/cm²) and Icaridin (MED 0.0150±0.004 mg/cm²).

TABLE 1
Minimum effective dose (MED) and half-repellent dose
(RD₅₀) values against female Aedes aegypti adults

| | | | | | |
|---|---|---|---|---|---|
| | | | Minimum | | |
| | | | Effective | RD₅₀ | RD₅₀ |
| | | | Dose | (30 min) | (60 min) |
| | | | (mg/cm²) | (μg/cm²) | (μg/cm²) |
| Compounds | Abbr. | MW | (Mean ± SEM)^{§} | (95% CI)^{¶} | (95% CI)^{¶} |

Non-Substituted Benzoates

| | | | | | |
|---|---|---|---|---|---|
| Methyl benzoate | MB*^{¥±} | 136 | >0.187 | >100 | >100 |
| Ethyl benzoate | EB*^{¥} | 150 | >0.187 | >100 | >100 |
| Vinyl benzoate | VB | 148 | >0.187 | >100 | >100 |
| n-Propyl benzoate | nPrB*^{¥±} | 164 | 0.250 ± | >100 | >100 |
| | | | 0.063^{c} | | |
| iso-Propyl benzoate | iPrB*^{¥±} | 164 | >0.187 | >100 | >100 |
| n-Butyl benzoate | nBB^{¥†±} | 178 | 0.148 ± | >100 | >100 |
| | | | 0.110^{c} | | |
| iso-Butyl benzoate | IBB*^{¥±} | 178 | >0.187 | 48.50 (34.97- | 52.17 (37.87- |
| | | | | 62.03)^{a} | 66.48)^{c} |
| n-Pentyl benzoate | nPeB^{¥±} | 192 | >0.187 | 42.65 (28.25- | 35.88 (24.63- |
| | | | | 57.05)^{a} | 47.13)^{a} |
| iso-Pentyl benzoate | iPeB*^{¥±} | 192 | >0.187 | 30.50 (19.63- | 27.75 (18.20- |
| | | | | 41.39)^{a} | 37.29)^{a} |
| n-Hexyl benzoate | nHB^{¥±} | 206 | >0.187 | 54.50 (31.64- | 32.54 (18.33- |
| | | | | 77.35)^{a} | 46.75)^{a} |
| Phenyl benzoate | PhB | 198 | >0.187 | >100 | >100 |
| Benzyl benzoate | BB*^{¥±} | 212 | >0.187 | >100 | >100 |
| Phenylethyl benzoate | PhEB*^{±} | 226 | >0.187 | >100 | >100 |

Substituted Benzoates
Methyl-Substituted

| | | | | | |
|---|---|---|---|---|---|
| Methyl 2- | M2MB^{±} | 150 | 0.250 ± | >100 | >100 |
| methylbenzoate | | | 0.063^{c} | | |
| Methyl 3- | M3MB^{±} | 150 | 0.219 ± | >100 | >100 |
| methylbenzoate | | | 0.083^{c} | | |
| Methyl 4- | M4MB^{±#} | 150 | >0.187 | >100 | >100 |
| methylbenzoate | | | | | |

Methoxy-Substituted

| | | | | | |
|---|---|---|---|---|---|
| Methyl 2- | M2MOB*^{¥±} | 166 | 0.049 ± | 29.34 (18.64- | 32.32 (20.63- |
| methoxybenzoate | | | 0.026^{a} | 40.05)^{a} | 44.01)^{a} |
| Methyl 3- | M3MOB^{±} | 166 | 0.266 ± | 31.54 (21.10- | 31.82 (18.33- |
| methoxybenzoate | | | 0.109^{c} | 41.98)^{a} | 45.32)^{a} |
| Methyl 4- | M4MOB*^{¥±#} | 166 | >0.187 | >100 | >100 |
| methoxybenzoate | | | | | |
| Ethyl 2- | E2MOB^{¥} | 180 | | 8.83 (5.89- | 8.87 (6.30- |
| methoxybenzoate | | | | 11.76)^{b} | 11.44)^{b} |
| Ethyl 4- | E4MOB*^{¥±} | 180 | >0.187 | 16.12 (9.42- | 11.31 (4.43- |
| methoxybenzoate | | | | 22.83)^{b} | 18.19)^{b} |

Hydroxy-Substituted

| | | | | | |
|---|---|---|---|---|---|
| Methyl 4- | M4HB*^{±#} | 152 | >0.187 | >100 | >100 |
| hyhroxylbenzoate | | | | | |
| n-Propyl 4- | nPr4HB*^{±#} | 180 | >0.187 | >100 | >100 |
| hydroxylbenzoate | | | | | |
| n-Butyl 4- | nB4HB*^{±#} | 194 | >0.187 | >100 | >100 |
| hydroxybenzoate | | | | | |

Chloro-Substituted

| | | | | | |
|---|---|---|---|---|---|
| Methyl 2- | M2CB | 170 | 0.164 ± | 28.72 (22.04- | 33.67 (25.40- |
| chlorobenzoate | | | 0.023^{c} | 35.40)^{a} | 41.95)^{a} |
| Methyl 4- | M4CB^{#} | 170 | >0.187 | >100 | >100 |
| chlorobenzoate | | | | | |

Trifluoromethyl-Substituted

| | | | | | |
|---|---|---|---|---|---|
| Methyl 4- | M4tFMB | 204 | >0.187 | >100 | >100 |
| (trifluoromethyl) | | | | | |
| benzoate | | | | | |

Aminosulfonyl-Substituted

| | | | | | |
|---|---|---|---|---|---|
| Methyl 2- | M2ASB^{#} | 215 | >0.187 | >100 | >100 |
| (aminosulfonyl) | | | | | |
| benzoate | | | | | |

Nitro-Substituted

| | | | | | |
|---|---|---|---|---|---|
| Methyl 2- | M2NB | 181 | 0.025 ± | 19.58 (3.57- | 13.13 (3.12- |
| nitrobenzoate | | | 0.012^{a} | 35.59)^{a} | 23.13)^{b} |

Amino-Substituted

| | | | | | |
|---|---|---|---|---|---|
| Methyl anthranilate | MA*^{¥±} | 151 | 0.027 ± | 11.84 (7.60- | 11.75 (7.43- |
| | | | 0.011^{a} | 16.09)^{b} | 16.06)^{b} |
| Methyl 4- | M4AB^{#} | 151 | >0.187 | >100 | >100 |
| aminobenzoate | | | | | |
| Ethyl anthranilate | EA*^{¥±} | 165 | 0.037 ± | 16.56 (7.97- | 16.17 (7.62- |
| | | | 0.029^{a} | 25.17)^{b} | 24.73)^{b} |
| Ethyl 3- | E3AB | 165 | 0.039 ± | >100 | >100 |
| aminobenzoate | | | 0.008^{a} | | |
| Allyl anthranilate | AA*^{¥} | 177 | 0.039 ± | 19.29 (13.76- | 14.79 (10.31- |
| | | | 0.028^{a} | 24.82)^{b} | 19.27)^{b} |
| n-Butyl anthranilate | nBA*^{¥±} | 193 | 0.066 ± | >100 | 52.81 (33.01- |
| | | | 0.028^{a} | | 72.61)^{c} |
| iso-Butyl anthranilate | iBA*^{¥} | 193 | | 30.63 (15.54- | 14.29 (9.01- |
| | | | | 45.72)^{a} | 19.58)^{b} |
| Methyl N- | MMA*^{¥±} | 165 | 0.063 ± | 19.87 (12.79- | 18.00 (12.15- |
| methylanthranilate | | | 0.016^{a} | 26.95)^{b} | 23.85)^{a} |
| Methyl N,N-dimethyl | MDMA*^{¥±} | 179 | 0.039 ± | 6.58 (4.84- | 5.67 (4.61- |
| anthranilate | | | 0.008^{a} | 8.33)^{b} | 6.74)^{b} |
| Methyl N- | MACA*^{¥#} | 193 | 0.101 ± | >100 | >100 |
| acetylanthranilate | | | 0.047^{c} | | |
| Methyl N- | MFA*^{¥±#} | 179 | 0.047 ± | >100 | >100 |
| formylanthranilate | | | 0.024^{a} | | |
| Ethyl N- | EFA^{#} | 193 | 0.0062 ± | >100 | >100 |
| formylanthranilate | | | 0.0025^{a} | | |
| n-Propyl N- | nPrFA | 207 | 0.0028 ± | >100 | >100 |
| formylanthranilate | | | 0.0011^{b} | | |
| n-Butyl N- | nBFA | 221 | 0.0075 ± | >100 | >100 |
| formylanthranilate | | | 0.0048^{a} | | |

Blends^{β}

| | | | |
|---|---|---|---|
| Ethyl 4- | E4MOB | 5.31 (3.89- | 4.88 (4.13- |
| methoxybenzoate | | 6.74)^{b} | 5.62)^{b} |
| Methyl N,N-dimethyl | MDMA | | |
| anthranilate | | | |
| Methyl 2- | M2NB | 14.58 (10.42- | 15.01 (10.59- |
| nitrobenzoate | | 18.74)^{b} | 19.41)^{b} |
| Methyl anthranilate | MA | | |

Standard Reference Compounds

| | | | | | |
|---|---|---|---|---|---|
| N,N-diethyl-m- | DEET | 191 | 0.0100 ± | 41.48 (30.17- | 29.86 (21.86- |
| toluamide | | | 0.003^{a} | 52.80)^{a} | 36.38)^{a} |
| 1-Piperidinecarboxylic | Icaridin | 229 | 0.0150 ± | | |
| acid 2-(2- | | | 0.004^{a} | | |
| hydroxyethyl)- | | | | | |
| 1-methylpropylester | | | | | |

^{§}Arm-in-Cage Assay. Means in the same column were individually compared with DEET by the Student's T-test at α = 0.05. Superscript letters indicate the following: ^{a}not significantly different than DEET; ^{b}significantly more effective than DEET.
^{¶}High-Throughput Screen Test. Means in the same column were individually compared with DEET by the “drc” package at α = 0.05 in R version 4.2.2. Superscript letters indicate the following: ^{a}not significantly different than DEET; ^{b}significantly more effective than DEET; ^{c}significantly less effective than DEET.
*FDA approved food flavoring agent or adjuvant.
^{†}FDA approved indirect food additive.
^{¥}EU approved food flavoring agent or adjuvant.
^{±}Natural product.
^{#}Solid.
^{β}All compounds were mixed in eaqual amounts in blends.

The blends that did not show 50% repellencies at a dose of 5 (μg/cm²) were not continued for the further evaluation.

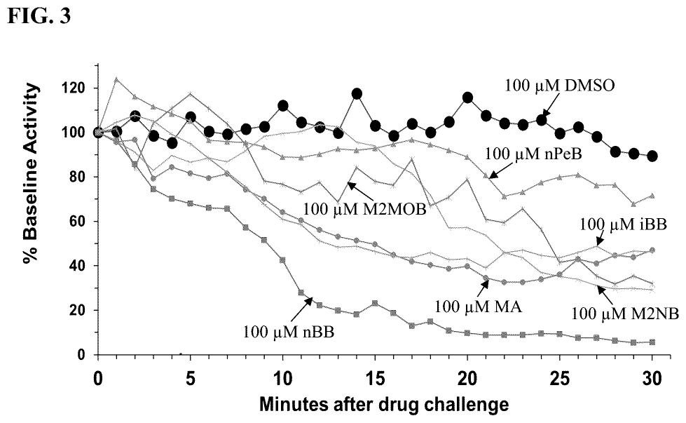

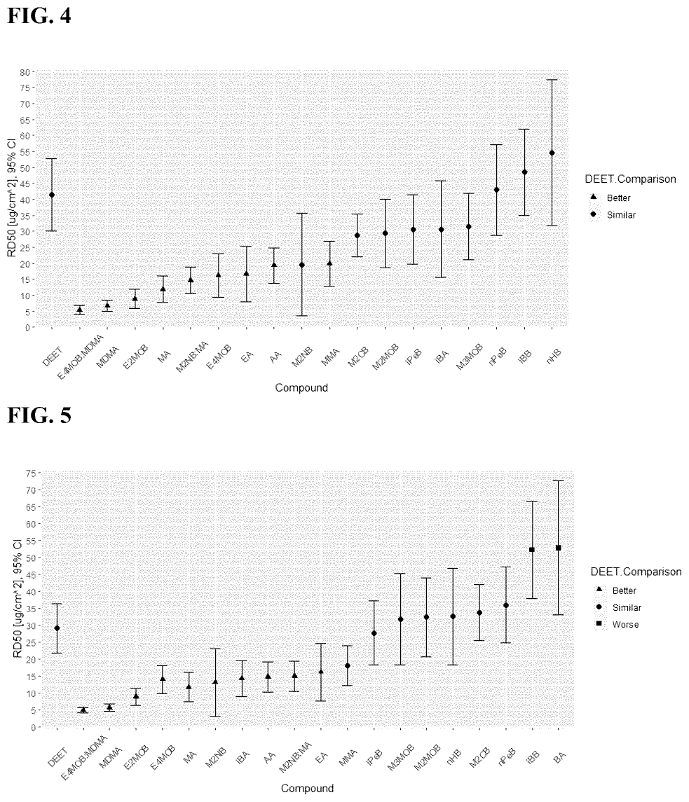

Spatial repellency evaluation As seen in Table 1 above, of the forty three benzoate analogs examined in high-throughput in vitro screening assays, 27 analogs (MB, EB, VB, nPrB, iPrB, nBB, PhB, BB, PhEB, M2 MB, M3 MB, M4 MB, M4MOB, M4HB, nPr4HB, nB4HB, M4CB, M4tFMB, M2ASB, M4AB, E3AB, nBA, MAcA, MFA, EFA, nPrFA, and nBFA) did not show spatial repellencies at the highest-tested dose of 100 μg/cm². As seen in Table 1 and FIG. 4, nine analogs (iBA, M2NB, M2CB, M3MOB, M2MOB, nHB, iPeB, nPeB, and iBB) displayed spatial repellencies at 30 minutes with half-repellency doses (RD₅₀) not significantly different from that of DEET. Similarly, as seen in Table 1 and FIG. 4, seven analogs (MDMA, E2MOB, MA, E4MOB, EA, AA, MMA) demonstrated spatial repellencies at 30 minutes with RD₅₀ values significantly lower than that of DEET. The three most repellent benzoates were MDMA, E2MOB, and MA, with 30-minute RD₅₀ values of 6.58, 8.83, and 11.84 μg/cm², respectively, compared to that of DEET at 42.56 μg/cm². A blend of two benzoates, MDMA and E4MOB, in a 1:1 ratio showed the lowest 30-minute RD₅₀ at 5.23 μg/cm².

Knockdown and lethality evaluation—As seen in FIG. 6A to FIG. 6E, and Table 2 below, during the high-throughput in vitro screening assay, only some alkyl benzoates, including iBB, nBB, iPeB, nPeB and nHB, exhibited considerable knockdown and mortality activities. Of the alkyl benzoates tested, the compound, nBB, was the most potent knockdown agent and toxicant with 30 minute half-knockdown doses (KD₅₀) of 2.78 μg/cm³ and 24 hour half-lethal dose (LD₅₀) of 4.05 μg/cm³. FIG. 6A to FIG. 6E show that most of these alkyl benzoates were capable of causing complete knockdown at doses ≤7 μg/cm³ within 60 minutes. For this reason, 7 μg/cm³ was generally the highest dose tested for knockdown properties of benzoate analogs.

Neurophysiological study—As seen in Table 2, five compounds, nBB, iBB, MA, M2NB, and iPeB, elicited nerve block in less than 30 minutes on the central nervous system of 4^{th} instar Ae. aegypti larvae at 100 μM concentration. FIG. 4 and Table 2 show that the compound, nBB, elicited the most potent nerve firing in 5 minutes, while it took more than 30 minutes for the compound, nPeB to provoke nerve block. The following rank in nerve block potency from the most potent to lease potent was observed: nBB (5 min)>iBB (9 min)>MA (10 min)>M2NB (19 min)>M2MOB (24 min)>nPeB (>30 min).

TABLE 2
Half-knockdown (KD₅₀) and half-lethality (LD₅₀) doses against female Aedes aegypti
adults and nerve firing time on Aedes aegypti larvae central nervous system

| | | | | | | Time |
|---|---|---|---|---|---|---|
| | | | KD₅₀ | KD₅₀ | LD₅₀ | to |
| | | | (30 min) | (60 min) | (24 h) | nerve |
| | | | (μg/cm³) | (μg/cm³) | (μg/cm³) | block |
| Compounds | Abbr. | MW | (95% CI) | (95% CI) | (95% CI) | (min) |
| n-Butyl | nBB | 178 | 2.81 | 3.09 | 4.05 | 5 |
| benzoate | | | (2.69-2.92)^{a} | (2.96-3.23)^{a} | (3.89-4.21)^{a} | |
| iso-Butyl | iBB | 178 | 5.26 | 5.29 | 5.09 | 9 |
| benzoate | | | (5.03-5.49)^{c} | (5.06-5.53)^{e} | (4.65-5.53)^{bc} | |
| n-Pentyl | nPeB | 192 | 4.77 | 3.98 | 5.07 | >30 |
| benzoate | | | (4.57-4.96)^{c} | (3.77-4.19)^{c} | (4.89-5.24)^{bc} | |
| iso-Pentyl | iPeB | 192 | 3.71 | 3.40 | 4.45 | |
| benzoate | | | (3.34-4.08)^{b} | (3.20-3.59)^{ab} | (3.90-5.00)^{ab} | |
| n-Hexyl | nHB | 206 | 7.06 | 4.72 | 4.83 | |
| benzoate | | | (6.01-8.12)^{d} | (4.54-4.90)^{d} | (4.65-5.01)^{b} | |
| nBB:iPeB* | nBiPmix | | 5.04 | 4.90 | 5.41 | |
| | | | (4.80-5.28)^{c} | (4.66-5.13)^{de} | (4.51-6.32)^{bc} | |
| nBB:nPeB* | nBPmix | | 4.34 | 3.65 | 5.37 | |
| | | | (4.17-4.52)^{c} | (3.47-3.82)^{b} | (5.20-5.54)^{c} | |
| nBB:nHB* | nBHmix | | 5.00 | 4.17 | 4.91 | |
| | | | (4.60-5.40)^{c} | (3.93-4.40)^{c} | (4.70-5.12)^{b} | |
| nBB:nPeB:nHB* | nBPHmix | | 4.87 | 4.38 | 4.43 | |
| | | | (4.68-5.06)^{c} | (4.21-4.55)^{c} | (4.19-4.67)^{ab} | |
| Methyl | MA | 151 | >7 | >7 | >7 | 10 |
| anthranilate | | | | | | |
| Methyl 2- | M2NB | 181 | >7 | >7 | >7 | 19 |
| nitrobenzoate | | | | | | |
| Methyl 2- | M2MOB | 166 | >7 | >7 | >7 | 24 |
| methoxybenzoate | | | | | | |
| N,N-diethyl-m- | DEET | 191 | >15 | >15 | 2.42 | |
| toluamide | | | | | (2.19-2.66)^{d} | |

*All compounds were mixed in equal parts.
Means in the same column followed by the different superscript letters are significantly different at a = 0.05, as determined by comparison of the 95% confidence intervals calculated with the “drc” package in R version 4.2.2.
Relative potency and accompanying “Time to Nerve Block” of various experimental compounds applied at 100 μM on the central nervous system of 4^{th} instar larvae for nerve block.

We claim:

1. A blood-sucking arthropod-repelling, -knocking down, and/or -killing composition comprising a solvent or diluent and a compound of Formula 1 or Formula 2: 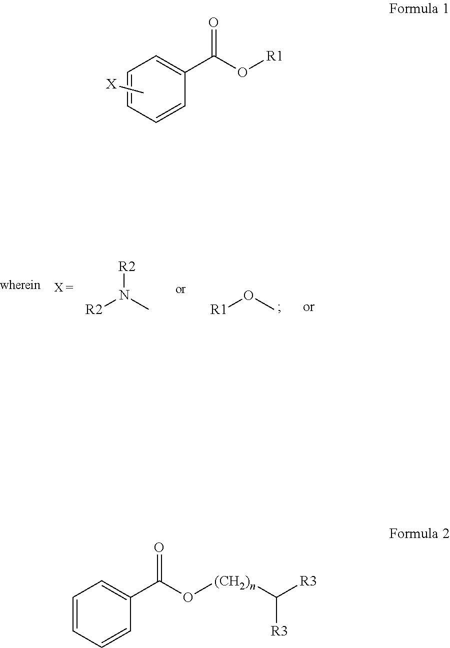
wherein
n is 1, 2, 3, or 4;
R1 are independently an alkyl or alkenyl group;
R2 are independently hydrogen, oxygen, aldehyde, ketone, acetyl, alkyl, or alkenyl group; and
R3 are independently hydrogen, halogen, or CH₃ groups.

2. The composition of claim 1, wherein the composition comprises at least two compounds of Formula 1, at least two compounds of Formula 2, or a combination thereof.

3. The composition of claim 1, wherein the composition is a blood-sucking arthropod-repelling composition and comprises a compound of Formula 1 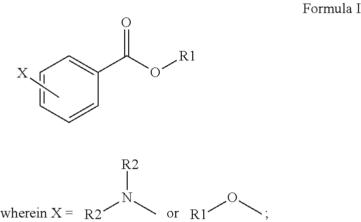
R1 is independently an alkyl or alkenyl group; and
R2 are independently hydrogen, oxygen, aldehyde, ketone, acetyl, alkyl, or alkenyl group.

4. The composition of claim 1, wherein the composition is a blood-sucking arthropod-knocking-down composition and comprises a compound of Formula 2 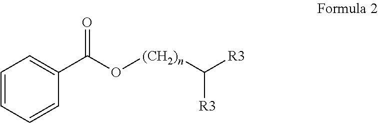
wherein
n is 1, 2, 3, or 4; and
R3 are independently hydrogen, halogen, or CH₃ groups.

5. The composition of claim 1, wherein the composition comprises at least one of methyl benzoate (MB), ethyl benzoate (EB), vinyl benzoate (VB), n-propyl benzoate (nPrB), n-butyl benzoate (nBB), benzyl benzoate (BB), methyl 2-chlorobenzoate (M2CB), methyl 2-nitrobenzoate (M2NB), iso-butyl benzoate (iBB), n-pentyl benzoate (nPeB), n-hexyl benzoate (nHB), methyl 3-methylbenzoate (M3 MB), iso-pentyl benzoate (also called iso-amyl benzoate) (iPeB), iso-propyl benzoate (iPrB), methyl 2-methoxybenzoate (M2MOB), ethyl 2-methoxybenzoate (E2MOB), ethyl 4-methoxybenzoate (E4MOB), methyl anthranilate (MA), Methyl 2-(aminosulfonyl)benzoate (M2ASB), n-butyl anthranilate (nBA), methyl 3-nitrobenzoate (M3NB), methyl 4-nitrobenzoate (M4NB), ethyl 3-aminobenzoate (E3AB), allyl anthranilate (AA), methyl 2-methylbenzoate (M2 MB), methyl 3-methoxybenzoate (M3MOB), ethyl anthranilate (EA), methyl N-methylanthranilate (MMA), methyl N,N-dimethylanthranilate (MDMA), iso-butyl anthranilate (iBA), methyl N-acetylanthranilate (MAcA), methyl N-formylanthranilate (MFA), ethyl N-formylanthranilate (EFA), n-Propyl N-formylanthranilate (nPrFA), or n-Butyl N-formylanthranilate (nBFA).

6. The composition of claim 2, wherein the composition comprises a blend of at least two of MB, EB, VB, nPrB, nBB, BB, M2CB, M2NB, iBB, nPeB, nHB, M3 MB, iPeB, iPrB, M2MOB, E4MOB, MA, M2ASB, nBA, M3NB, M4NB, E3AB, AA, M2 MB, M3MOB, EA, MMA, MDMA, iBA, MAcA, MFA, EFA, nPrFA, or nBFA.

7. A method for repelling, knocking down, and/or killing blood-sucking arthropods, the method comprising treating an object or area in need thereof with an effective amount of arthropod-repelling, knocking down, and/or killing composition of claim 1.

8. The method for repelling, knocking down, and/or killing blood-sucking arthropods of claim 7, the method comprising treating an object or area in need thereof with an effective amount of an arthropod-repelling, knocking down, and/or killing composition comprising at least two compounds of Formula 1, two compounds of Formula 2, or a combination thereof.

9. A method for repelling blood-sucking arthropods, the method comprising treating an object or area in need thereof with an effective amount of arthropod-repelling composition of claim 3.

10. A method for repelling or knocking down blood-sucking arthropods, the method comprising treating an object or area in need thereof with an effective amount of a composition of claim 4.

11. The method of claim 7, wherein blood-sucking arthropods are mosquitoes, sandflies, flies, tabanids, lice, sheep ked, fleas, ticks, mites, spiders, centipedes, scorpions, or chiggers.

12. The method of claim 7, wherein the blood-sucking arthropods are adults, larvae, nymphs, pupae, or eggs.

13. The method of claim 7, wherein the composition comprises at least one of MB, EB, VB, nPrB, nBB, BB, M2CB, M2NB, iBB, nPeB, nHB, M3 MB, iPeB, iPrB, M2MOB, E4MOB, MA, M2ASB, nBA, M3NB, M4NB, E3AB, AA, M2 MB, M3MOB, EA, MMA, MDMA, iBA, MAcA, MFA, EFA, nPrFA, or nBFA.

14. The method of claim 13, wherein the composition comprises a blend of at least two of MB, EB, VB, nPrB, nBB, BB, M2CB, M2NB, iBB, nPeB, nHB, M3 MB, iPeB, iPrB, M2MOB, E4MOB, MA, M2ASB, nBA, M3NB, M4NB, E3AB, AA, M2 MB, M3MOB, EA, MMA, MDMA, iBA, MAcA, MFA, EFA, nPrFA, nBFA, or a combination thereof.

15. A kit for repelling, knocking down, or killing blood-sucking arthropods, the kit comprising a composition of claim 1.

16. A kit for repelling blood-sucking arthropods, the kit comprising a composition of claim 3.

17. A kit for knocking down blood-sucking arthropods, the kit comprising a composition of claim 4.

18. The kit of claim 15, wherein the composition comprises at least one of MB, EB, VB, nPrB, nBB, BB, M2CB, M2NB, iBB, nPeB, nHB, M3 MB, iPeB, iPrB, M2MOB, E4MOB, MA, M2ASB, nBA, M3NB, M4NB, E3AB, AA, M2 MB, M3MOB, EA, MMA, MDMA, iBA, MAcA, MFA, EFA, nPrFA, or nBFA.

19. The kit of claim 18, wherein the composition comprises a blend of at least two of MB, EB, VB, nPrB, nBB, BB, M2CB, M2NB, iBB, nPeB, nHB, M3 MB, iPeB, iPrB, M2MOB, E4MOB, MA, M2ASB, nBA, M3NB, M4NB, E3AB, AA, M2 MB, M3MOB, EA, MMA, MDMA, iBA, MAcA, MFA, EFA, nPrFA, nBFA, or a combination thereof.

20. A compound of Formula 1, 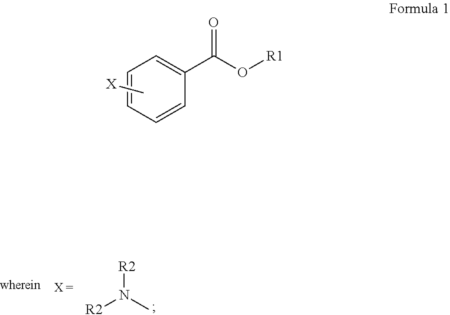
R1 is an alkyl or alkenyl group; and
R2 are independently hydrogen, oxygen, aldehyde, ketone, acetyl, alkyl, or alkenyl group; and
wherein the compound is EFA, nPrFA, or nBFA.
